(19) United States
(12) Patent Application Publication
(10) Pub. No.: US 2013/0080135 A1
(43) Pub. Date: Mar. 28, 2013

(54) SYSTEM, TOOL AND METHOD FOR INTEGRATED CIRCUIT AND COMPONENT MODELING

(71) Applicant: La Vida D. Cooper, Rockville, MD (US)

(72) Inventor: La Vida D. Cooper, Rockville, MD (US)

(73) Assignee: USA AS REPRESENTED BY THE ADMINISTRATOR OF THE NATIONAL AERONAUTICS AND SPACE ADMINISTRATION, WASHINGTON, DC (US)

(21) Appl. No.: 13/247,416

(22) Filed: Sep. 28, 2011

(51) Int. Cl. G06F 17/50

(52) U.S. Cl. 703/14

(57) ABSTRACT

A system, tool and method for testing and modeling capabilities and functionalities of an integrated circuit or components thereof in an extreme environment, particularly for temperatures encountered in outer space, lunar and planetary environments.

### ORIGIN OF THE INVENTION

The invention described herein was made by an employee of the United States Government, and may be manufactured and used by or for the Government for governmental purposes without the payment of any royalties thereon or therefor.

### BACKGROUND OF THE INVENTION

1. Field of the Invention

The present invention is in the technical field of modeling integrated circuit and components thereof, such as transistors, particularly for usage in extreme environments

2. Description of Related Art

Integrated circuits employing transistors form the backbone for today's electronics industries, and find a wide range of applications since their introduction in the 1950's to the present. From computers to appliances virtually every device employs integrated circuits and transistors.

Although useful for many devices and applications, integrated circuits and transistors operate under tolerances, and have finite limits for proper operations. Nowhere are these limits most tested than in the depths of Outer Space, where extreme temperatures and other requirements test the boundaries of physical material constraints.

At present, there are no commercially available low temperature capable models or tools to ascertain the behavior of integrated circuitry and transistors in extreme environments. In particular, there are no systems or methods for modeling or simulating integrated circuitry behavior at extreme temperatures, especially temperatures such as those encountered in space, on the Moon or on other planetary bodies, all having diverse and harsh environmental challenges. Likewise, there are no available systems to test integrated circuitry and components under many other harsh conditions, such as exposure to acidic atmospheres, extreme pressures and other extreme situations encountered or encounterable by man-made equipment in an exploration.

What is needed is a tool to assess and describe the low temperature and other characteristic functionalities of transistor-based integrated circuits in a variety of environments, such as harsh planetary and lunar environments, as well as extreme terrestrial environments, such as volcanoes and in deep water.

### SUMMARY OP THE INVENTION

These needs are met by the present invention, which provides a method and system for evaluating and modeling integrated circuitry functionalities and capabilities at low temperature or other extreme conditions.

### BRIEF DESCRIPTION OF THE DRAWINGS

While the specification concludes with claims particularly pointing out and distinctly claiming the subject matter that is regarded as forming the present invention, it is believed that the invention will be better understood from the following Detailed Description, taken in conjunction with the accompanying Drawings, where like reference numerals designate like structural and other elements, in which:

FIG. 1 illustrates a system employing the principles of the present invention;

FIG. 2 is a graph simulation of an exemplary integrated circuit done at room temperature;

FIG. 3 is a graph simulation of the exemplary integrated circuit of FIG. 2, but done at an extreme temperature, such as 20 degrees Kelvin;

FIG. 4 illustrates initial curves of various functionalities at a baseline condition prior to usage of the principles of the present invention, demonstrating the variance between the standard curve fit or estimate of the given functionalities and the real measurements;

FIG. 5 is a second curve plotted from the baseline curve depicted in FIG. 4 for the exemplary integrated circuit or components thereof, illustrating various functionalities at a desired environmental condition, such as in outer space, after some usage of the principles of the present invention, demonstrating a closer correlation between the curve fit pursuant to the present invention and actual measurement; and

FIG. 6 is a third and improved curve plotted from the curves shown in FIGS. 4 and 5 for the exemplary integrated circuit or components thereof, better illustrating various functionalities at a desired environmental condition, after further usage of the principles of the present invention to better approximate the true functionality of the components in question, demonstrating an even closer correlation between the curve fit pursuant to the present invention and actual measurement.

### DETAILED DESCRIPTION OF THE INVENTION

The present invention will now be described more fully hereinafter with reference to the accompanying Drawings, in which preferred embodiments of the invention are shown. It is, of course, understood that this invention may, however, be embodied in many different forms and should not be construed as limited to the embodiments set forth herein; rather, these embodiments are provided so that the disclosure will be thorough and complete, and will fully convey the scope of the invention to those skilled in the art. It is, therefore, to be understood that other embodiments can be utilized and structural changes can be made without departing from the scope of the present invention.

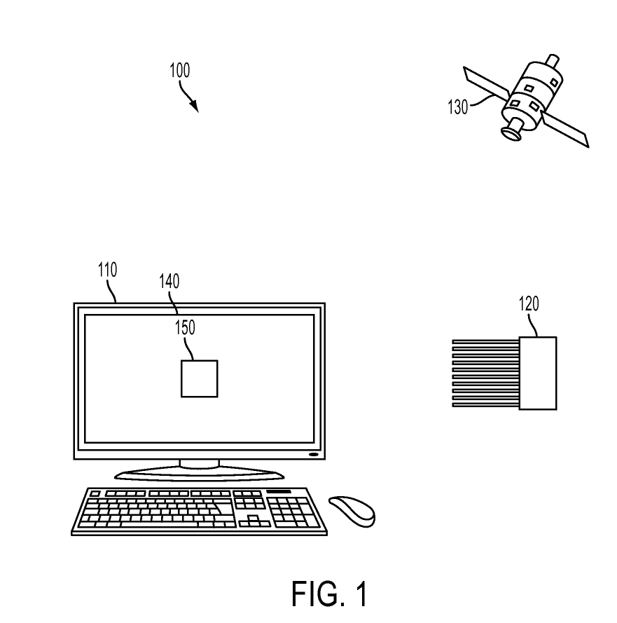

With reference to FIG. 1 of the drawings, there is illustrated therein a system employing the principles of the present invention, generally designated by the reference numeral 100. A computer at 110 having memory, interface, inputs and displays, as is understood in the art, is employed to allow a user to test or model the extreme temperature/environment functionalities or capabilities of an integrated circuit thereof, such as a test transistor, of interest to the user, generally designated by the reference numeral 120. It should, of course, be understood that the user need not actually have the physical transistor 120 for such modeling, and may instead rely on a listing or description of the various physical properties of the transistor or other integrated circuit components, such as listed in the manufactures' technical specifications. It should be understood that although only one component, transistor 120 is depicted, an integrated circuit or circuitry employing the component may instead be so modeled, or entire electronic systems or subsystems that are more complicated can be modeled on the apparatus or tool of the present invention. As discussed, the transistors or integrated circuitry 120 so tested are preferably employed in extreme environments via probes, generally designated in FIG. 1 by the reference numeral 130, which could operate in the extremes of space or terrestrial environments that are toxic or otherwise dangerous to humans or machines.

In an effort to better exemplify the technique of the instant invention, below are some illustrative descriptions of some aspects of the invention. First shown are some transistor test sweeps, i.e., some steps for testing transistor capabilities pursuant to the present invention. Preferably and for simplicity in this embodiment, the only user-inputted parameter is the anticipated temperature under which the transistor is to function, i.e., the operating temperature of the environment, and another the vacuum of space, the moon or another heavenly body. It should, of course, be understood that alternate or additional conditions can be modeled accordingly.

As is understood in the art, all transistors have various parameters already associated with them, particularly those the manufacturer releases. All of these data define various operational paradigms for the transistor in question, and create a so-called baseline model for performance. Usually, however, the operational temperature is not such a variable, and transistor testing is generally done at 300 degrees Kelvin, i.e., room temperature.

Below is a transistor test sweep to create some test protocols and performance characteristics pursuant to the present invention.

### Transistor Test Sweeps

1. ID vs VG
a. VD=0.1 v
b. VG=0 v-3.3 v; step=0.05 v or 0.1 v
c. VS=0 v (n); 3.3 v (p)

2. ID vs VD
a. VD=0 v-3.3 v; x-axis increment=0.05 v
b. VG=0.v9-3.3 v; step=0.4 v (other options 0.1 v or 0.6 v)
c. VS=0 v (n); 3.3 v (p)

3. ID vs VG
a. VD=3.3 v
b. VG=0 v-3.3 v; step=0.05 v or 0.1 v
c. VS=0 v (n); 3.3 v (p)

As illustrated, tests are first run on the drain current (or to those skilled in the art, ID) verse the gate voltage or VG. These are iterative steps, with the initial value of the voltage drain (VD) at 0.1 volts, and stepping through values for the gate voltage until the voltage source (VS) is either zero volts for nmos transistors or 3.3 volts for pros transistors.

Similarly, various runs are made of ID versus VD, and ID versus VG, as shown hereinabove. As discussed, these are test protocols to ascertain performance characteristics pursuant to the instant invention. After these protocols are run and data obtained, curves are plotted pursuant to the data points set and increments advanced, as noticed above. It should be understood that this conversion of raw data to curve fitting can be accomplished through various means, allowing easier determination of those parameters that impact the curve the must, e.g., a least squares methodology.

Further to the above test sweeps for transistors, below are some additional data determinators e.g., the data set size or critical mass or threshold number needed to obtain the derivative of the curve. Again, these paradigm for test sweeps and data set size are exemplary of the tools pursuant to the present invention.

### Data Set Size and Notes

1. ID vs VG (VD=0.1 v)
a. Common data set size: 51-101 data points.
b. This is important when taking derivatives; for example when the software tries to fit those parameters which are based on the derivatives of another parameter plot.

ID vs VD
a. Do not take VD below threshold or down to “0 v”; this data generally throws off the it (3-4 lines piled at the base of the plot for low level ID currents) for the rest of the plot because most optimizers use a weighted scheme to fit.
b. Common to have an average of 5-8 steps for any terminal being coarsely swept, for example VG for a ID vs VD plot.

Similar to the aforementioned methodologies set forth hereinabove, some illustrated strategy steps are described herein to further describe the principles of the present invention. As discussed, semiconductors and transistors have various physical attributes or characteristics that are part of the fabrication process and known to industry, usually by way of manufacturer's specifications. For example, T_{OX} is the oxide thickness of the semiconductors, which is part of the physics of the material, public information on a base parameter of the foundry process, as is understood to those of skill in the art. Likewise, T_{NOM} is the nominal temperature, e.g., room temperature.

Regarding device size, width by length, usually a square to facilitate fabrication, there are other industry-known parameters, per particles components and fabricators. For example, Uₐ relates to threshold voltage (Vtho), and Uₒ relates to the mobility of the electrons flowing through a transistor channel. Below are some strategy steps that may be employed in practicing the present invention.

### Strategy Steps

Exemplary strategy steps in practicing the instant invention include:

1. Fill in “initial” parameter file or chart with base values, per the physical attributes of the fabrication process.
a. Pay attention to the “Tox”, and TNOM values
b. Account for process specific characteristics
   i. For transistors in the Peregrine Fabrication process: Set relevant bulk related parameters to “0” or sufficiently low to get working model and create the baseline.
      1, Example: Parameter K2 (Vb based parameter)=0
   2. Example: Parameter K1 (Vb based parameter)=0.0001; This parameter cannot be set to 0 because it is in the numerator of another parameter equation, but it does need to be set sufficiently low to reflect the reality of no Vb.
   ii. If dealing with a fabrication process with another defining feature, identify all BSIM parameters that that are impacted and set them to the appropriate levels outlined in the manual for nominal values this will assist in obtaining a decent curve fit initially.
2. Device Size: Square Devices (transistor gate W=L, beginning with minimum size transistors and increasing to at least ten times or more of the minimum length.)
   a. Plot Id vs VG, VD=0.1 v measured data
   b. Extract Parameter: Vth0 and U0 (threshold and mobility)
      i. This means alter these two parameters until the model curve is as close as possible to matching the measured data. Based upon the measured data and process, the parameters may need to be increased or decreased and it is important to monitor their relative impacts on the curve, so use one at a time ideally. Rough calculations may also be attempted to get but this activity is most effective via visual inspection relative to the measured data.
      ii. Once the maximum impact on the curve fit has been achieved by these two parameters to closely mimic the measured data, move on to altering the secondary mobility parameters. The Vth0 & U0 will impact where the model curve “turns on” and the slope.
   c. Extract Parameter: Ua (first order roll-off and shaping related to the threshold)
   d. Extract Parameter: Ub (second order roll-off and shaping related to the threshold)
   e. Repeat this process for all square devices, at a specific temperature, then also as a final check add all square device measured data to the same plot window as a final check of the model curve to see if any of the first or secondary threshold or mobility parameters need to be fine tuned.
   f. Once the visual inspection and software calculated error as at an acceptable level, extract a model card with the full collection of BSIM parameters (model card #1). This model card #1 will be the basis of the next visual fit as additional parameters are altered for the ID vs VD plot for length and width arrays.
3. Device Size: Length Array (holding the transistor width as a constant and incrementally increasing the gate length up to at least ten times the minimum length or more)
   a. Plot ID vs VD measured data; Starting with one of the transistors in the length array (and working from model card #1 as the baseline model card within the extraction software.),
   b. Extract Parameter Vsat, Saturation voltage
      i. Repeat this process for all transistors in the length array, for a specific temperature, then also as a final check add all length array measured data to the same plot window as a final check of the model curve to see if Vsat need to be fine tuned, especially paying attention to the transistor with the largest ratio.
      ii. Once the visual inspection and software calculated error is at an acceptable level, extract a model card with the full collection of BSIM parameters (model card #2). This model card #2 will be the basis of the next visual fit as additional parameters are altered for the ID vs VD plot step for square devices.
4, Device Size: Width Array (holding the transistor length as a constant and incrementally increasing the gate length up to at least ten times the minimum width or more)
   a. Plot ID vs VD measured data; Starting with one of the transistors in the width array and model card #1 as a baseline model card
   b. Identify and Record Parameter Vsat, Saturation voltage
      i. Repeat this process for all transistors in the length array, for a specific temperature, then also as a final check add all width array measured data to the same plot window as a final check of the model curve to see if Vsat need to be fine tuned, especially paying attention to the transistor with the largest ratio
      ii. “Record” the best fit number for the width array “Vsat” parameter, this will be utilized later in the strategy for fine tuning in the end.
5. Device Size: Large Square Device
   a. Plot ID vs VD measured data
   b. Extract Parameter Ao, AGS (coefficients)
      i. Use model card #2 as a baseline for the curve fitting extraction, by altering these two parameters, achieve the best fit which minimizes the calculated errors or at minimum fine tunes a priority area of the curve. If low error fit proves difficult, slowly increment/decrement Vsat parameter to the recorded value to achieve a better fit, Extract model card #3,
   g. Plot the transconductance characteristic
      i. Using model card #3 as a baseline
         1. Extract Parameters: PCLM, DELTA, PDIBLC1, PDIBLC2, and DROUT. Extract one at a time optimizing the curve fit.
         2. Extract model card #4 thus producing the final model card.
6. Temperature binning step
   a. The defined strategy will produce a “binned” model card approach to low temperature/extreme environment transistor modeling. More specifically, the outlined strategy will need to be followed to produce a model for each discrete targeted temperature that may be needed for simulation.
      i For example: one can produce binned models for the following temperatures, depending on the application: 300 K, 200K, 100K, 90K, 80K, 77K, 70K, 60K, 50K, 40K, 30K, 20K, 15K for a specific application in space/aerospace, a wide range of testing may be needed for margin or to account for operational or in orbit temperature conditions that expose electronics to such a wide range of temperatures. Thus at minimum the complete strategy will need to be followed for the NMOS and PMOS transistors extracting a final model for each of the listed temperatures based upon measured data from test devices that were tested at the temperature with the specified test sweeps discussed earlier. Thus, for this example, given the temperature profile of 13 discrete temperatures for 2 transistors, there would be a total of 26 model cards extracted an NMOS and PMOS model at each of the listed temperatures. In addition, if the Fabrication company has any transistors with “special characteristics” like variable thresholds, etc., this distinction would also need to be made, thus using the Peregrine process as an example, which has 6 transistor types, a total of 78 model cards would need to be produced with 6 distinct model cards (one for each transistor type) being produced at each of the 13 temperatures. This should illustrate the meaning and intent of a binned approach as utilized within the scope of the instant description of the principles of the present invention.

The strategy/strategies outlined above achieve modeling by preferably focusing on high impact parameters and by extracting in order of “most” impact and building upon each subsequent extraction as a basis of the next curve fitting step.

### CAD Software Tool Simulation Guidance:

Once the model cards of the appropriate quantity are extracted and carefully named, for configuration management, they should be stored in a designated model file directory or database on a computer. A microchip design software package (for example: Cadence) used for integrated circuit design, typically comes with a functional performance simulator. After circuit schematics are constructed in the software consisting of multiple transistors connected in various topologies with varying gate widths and lengths depending on the desired electrical performance, a functional performance simulation can be run, by using the simulator and directing the simulator to use one or more as needed of the temperature specific model cards for the various transistor types, something usually achieved by telling the simulator the “location/directory” of the model cards and the name of the model card file. Additionally, it should be understood that it is typical to make a master model card of sorts that sequentially lists all transistor models for a specific temperature.

Using the above system and methodology, anything from simple circuits with a few transistors can be simulated, hut, as discussed hereinabove, the present invention can also be used to simulate complex circuits with orders of magnitude more transistors, which is especially true for hierarchical integrated designs that are composed of multiple design blocks, some of which are instantiated numerous times in order to systematically build a larger system, ultimately building a larger top level that can be composed of thousands if not millions of individual transistors.

Employing the above methodology, and the various raw data and model cards from manufacturers (or obtained via testing) and such, one of skill in the art may generate curves that can exemplify the effects of lower temperatures on a semiconductor or transistor component or larger system subjected to a variable temperature or other conditions.

Accordingly, a software application with input fields 150, one or dozens, such as described hereinabove, are displayed on the display screen of the aforementioned computer system 110, designated by the reference numeral 140, through which a user may interface in order to test a proposed integrated circuit or component thereof, generally designated by the reference numeral 120. For example, the tester may interact with an input field, drop down box or other selection means, generally designated by the reference numeral 150, to input or select data. As described hereinabove and shown in FIG. 1, a variety of parameters, both physical and functional, may be displayed and selected pursuant to the teachings of the present invention, e.g., through a mouse, typed or other input and selection, as is understood in the art. Additionally, the aforementioned curve fitting may be displayed on the monitor or display 140, permitting visual inspection of the process if needed, e.g., to attain a particular degree of curve fit or delta, described further hereinbelow. Also, the simulation and the results therefrom may also be so displayed on the monitor 140 to the user, providing a visual representation, and any data generated thereby stored in a memory or database on the computer 110, as is understood in the art.

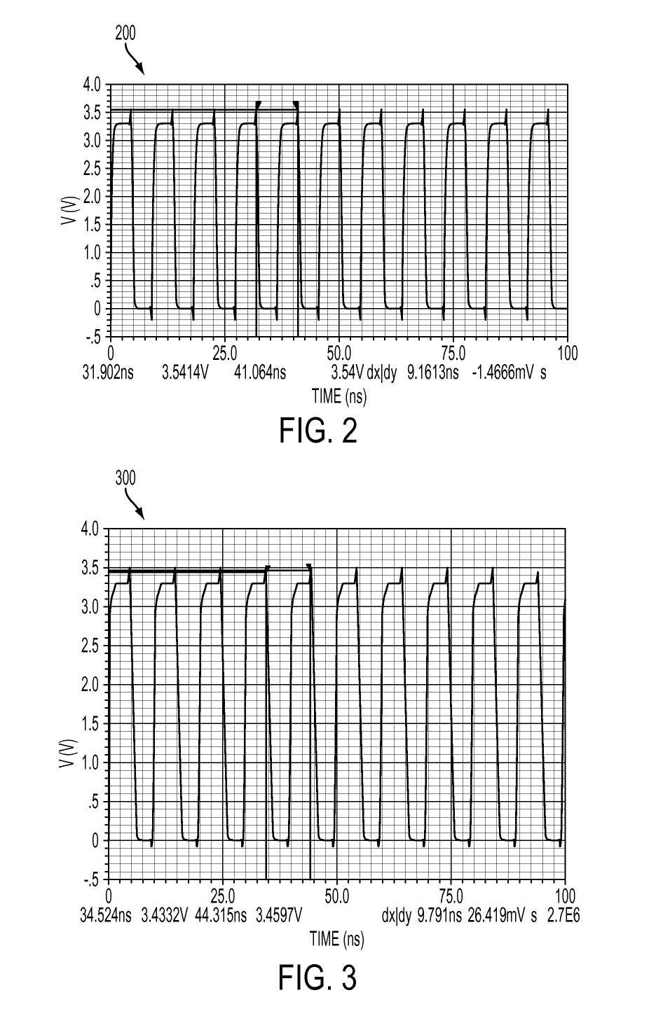

Shown in FIG. 2 of the Drawings, there is shown a graph simulation of a component pursuit to the present invention, a 100 MHz oscillator design, generally designated by the reference numeral 200. The environmental conditions for this model, employing the various fabricator's and manufacturer's physical constraints and characteristics are 300 degrees Kelvin, about room temperature. The design being tested here employs 42 transistors and 21 invertors.

As discussed, the design shown in FIG. 2 uses 21 (1.5/1) size inverters. An oscillator is a basic circuit comprised of a string of inverters (2 transistor circuit) connected together, input to output, that oscillates, in this case between the ground voltage of 0 v and the vdd/rail voltage of 3.3 v, at a fixed frequency dependent upon the threshold of the inverter design and the number of inverter stages selected. The circuit shown in FIG. 2 illustrates, using the 300K model generated, how many transistors of what inverter ratio composed the design under these particular conditions.

With reference now to FIG. 3 of the Drawings, however, there is shown another simulation, generally designated by the reference numeral 300, that is based on the configuration employed in FIG. 2, but with the environmental conditions changed to 20 degrees Kelvin, i.e., near absolute zero, a quite cold environment, as would be encountered in outer space. The simulation shows that a new inverter ratio and quantity are needed to achieve the same oscillation frequency as shown in FIG. 2.

Under the conditions set forth in the user's scenario, i.e., the 20 degrees Kelvin option input into the field 150 on the computer 110, the functionality of the 100 MHz oscillator design, requiring 21 inverters at 300 degrees Kelvin, drops to 13 minimum size invertors, dramatically demonstrating some of the operational changes of the components in an different environment. In other words, the tools of the present invention illustrate unexpected performance possibilities in the environment of intended usage.

As discussed, transistors and other components have various characteristics associated with them, dependent on their model and foundry site. For MOSFET transistors, there are a family of transistor models employed in connection with circuits, permitting electronic circuit simulations and such necessary for integrated circuit design. To attempt some standardization of the models so that a set of model parameters may be employed in different simulators, Berkeley Short-channel IGFET Models (BSIMs) have been developed, and employed herein for convenience.

The particular extreme environment model developed is specific to the transistors in the Peregrine Semiconductor Fabrication Foundry's-0.5 micrometer (μm), Silicon on Sapphire (SOS) process. In particular, the Regular NMOS (RN), Regular PMOS (RP), Middle Voltage Threshold NMOS (NL), and Middle Voltage Threshold PMOS (PL) transistors, which are 4 of the total of 6 types of transistors offered by the Peregrine Foundry; the other 2 transistor types have not been modeled, however the raw data needed has been collected via testing, and the data collection and extraction methods described can be used to produce the models for the Intrinsic NMOS (IN) and Intrinsic PMOS (IP) transistors, as is understood in the art.

The type of model used as a basis for which the parameters are altered to reflect the extreme environment temperature functionality is the BSIM3 (Version3.3) model. The actual data files for the 20 Kelvin transistor models are shown below. The data files can be used in conjunction with any transistor simulator software tool used during the design flow process, such as Cadence Spectre or the like.

Actual BSIM Model parameters for the operation of an RN transistor (type n) at 20 degrees Kelvin are:

| | | |
|---|---|---|
| +version = 3.3 | tnom = −253 | tox = 1.4e−08 |
| +xj = 1.5e−07 | nch = 1.7e+1.7 | vth0 = 1.15 |
| +k1 = 1e−07 | k2 = 0 | k3 = 0 |
| +k3b = 0 | w0 = 2.5e−06 | nlx = 1.74e−07 |
| +dvt0w = 0 | dvt1w = 0 | dvt2w = −0.032 |
| +dvt0 = 2.2 | dvt1 = 0.53 | dvt2 = 0 |
| +u0 = 0.0832857 | ua = 1.16586e−08 | ub = 3.78634e−18 |
| +uc = 0 | vsat = 6500 | a0 = 0.1 |
| +ags = 0 | b0 = 0 | b1 = 0 |
| +keta = −0.047 | a1 = 0 | a2 = 1 |
| +rdsw = 0 | prwg = 0 | prwb = 0 |
| +wr = 1 | wint = 0 | lint = 0 |
| +xl = 0 | xw = 0 | dwg = 0 |
| +dwb = 0 | voff = −0.1 | nfactor = 1 |
| +cit = 0 | cdsc = 0.00024 | cdscd = 0 |
| +cdscb = 0 | eta0 = 0.08 | etab = −0.07 |
| +dsub = 0.56 | pclm = 1.3 | pdiblc1 = 0.39 |
| +pdiblc2 = 0.0086 | pdiblcb = 0 | drout = 0.56 |
| +pscbe1 = 4.2e+08 | pscbe2 = 5e−05 | pvag = 0 |
| +delta = 0.01 | mobmod = 1 | prt = 0 |
| +ute = −1.5 | kt1 = 0 | kt1l = 0 |
| +kt2 = 0 | ua1 = 4.3e−09 | ub1 = −1e−17 |
| +uc1 = −5.6e−11 | at = 33000 | nqsmod = 0 |
| +wl = 0 | wln = 1 | ww = 0 |
| +wwn = 1 | wwl = 0 | ll = 0 |
| +lln = 1 | lw = 0 | lwn = 1 |
| +lwl = 0 | capmod = 2 | tpb = 0 |
| +tpbsw = 0 | tpbswg = 0 | tcj = 0 |
| +tcjsw = 0 | tcjswg = 0 | noff = 1 |
| +acde = 1 | moin = 15″ | |

Actual BSIM Model parameters for the operation of an RP transistor (type p) at 20 degrees Kelvin are:

| | | |
|---|---|---|
| +version = 3.3 | tnom = −253 | tox = 9.5e−09 |
| +xj = 1.5e−07 | nch = 1.7e+17 | vth0 = −0.700885 |
| +k1 = 0.0001 | k2 = 0 | k3 = 80 |
| +k3b = 0 | w0 = 2.5e−06 | nlx = 1.74e−07 |
| +dvt0w = 0 | dvt1w = 0 | dvt2w = 0 |
| +dvt0 = 2.2 | dvt1 = 0.53 | dvt2 = 0 |
| +u0 = 0.0159735 | ua = 4.43673e−09 | ub = 5e−18 |
| +uc = 0 | vsat = 80000 | a0 = 1 |
| +ags = 0 | b0 = 0 | b1 = 0 |
| +keta = −0.047 | a1 = 0 | a2 = 1 |
| +rdsw = 0 | prwg = 0 | prwb = 0 |
| +wr = 1 | wint = 0 | lint = 0 |
| +xl = 0 | xw = 0 | dwg = 0 |
| +dwb = 0 | voff = −0.1 | nfactor = 1 |
| +cit = 0 | cdsc = 0.00024 | cdscd = 0 |
| +cdscb = 0 | eta0 = 0.08 | etab = 0 |
| +dsub = 0.56 | pclm = 1.3 | pdiblc1 = 0.39 |
| +pdiblc2 = 0.0086 | pdiblcb = 0 | drout = 0.56 |
| +pscbe1 = 4.2e+08 | pscbe2 = 5e−05 | pvag = 0 |
| +delta = 0.01 | mobmod = 1 | prt = 0 |
| +ute = −1.5 | kt1 = 0 | kt1l = 0 |
| +kt2 = 0 | ua1 = 4.3e−09 | ub1 = −7.6e−18 |
| +uc1 = −5.6e−11 | at = 33000 | nqsmod = 0 |
| +wl = 0 | wln = 1 | ww = 0 |
| +wwn = 1 | wwl = 0 | ll = 0 |
| +lln = 1 | lw = 0 | lwn = 1 |
| +lwl = 0 | capmod = 2 | tpb = 0 |
| +tpbsw = 0 | tpbswg = 0 | tcj = 0 |
| +tcjsw = 0 | tcjswg = 0 | noff = 1 |
| +acde = 1 | moin = 15″ | |

Actual BSIM Model parameters for the operation of a NL transistor (type n) at 20 degrees Kelvin are:

| | | |
|---|---|---|
| +version = 3.3 | tnom = −253 | tox = 9.5e−09 |
| +xj = 1.5e−07 | nch = 1.7e+17 | vth0 = 0.72 |
| +k1 = 0.0001 | k2 = 0 | k3 = 80 |
| +k3b = 0 | w0 = 2.5e−06 | nlx = 1.74e−07 |
| +dvt0w = 0 | dvt1w = 0 | dvt2w = 0 |
| +dvt0 = 2.2 | dvt1 = 0.53 | dvt2 = 0 |
| +u0 = 0.0854161 | ua = 1.28532e−08 | ub = 1e−21 |
| +uc = 0 | vsat = 10000 | a0 = 0.876642 |
| +ags = 4.9635 | b0 = 0 | b1 = 0 |
| +keta = −0.047 | a1 = 0 | a2 = 1 |
| +rdsw = 0 | prwg = 0 | prwb = 0 |
| +wr = 1 | wint = 0 | lint = 0 |
| +xl = 0 | xw = 0 | dwg = 0 |
| +dwb = 0 | voff = −0.1 | nfactor = 1 |
| +cit = 0 | cdsc = 0.00024 | cdscd = 0 |
| +cdscb = 0 | eta0 = 0.08 | etab = 0 |
| +dsub = 0.56 | pclm = 1.3 | pdiblc1 = 0.39 |
| +pdiblc2 = 0.0086 | pdiblcb = 0 | drout = 0.56 |
| +pscbe1 = 4.2e+08 | pscbe2 = 5e−05 | pvag = 0 |
| +delta = 0.01 | mobmod = 1 | prt = 0 |
| +ute = −1.5 | kt1 = 0 | kt1l = 0 |
| +kt2 = 0 | ua1 = 4.3e−09 | ub1 = −7.6e−18 |
| +uc1 = −5.6e−11 | at = 33000 | nqsmod = 0 |
| +wl = 0 | wln = 1 | ww = 0 |
| +wwn = 1 | wwl = 0 | ll = 0 |
| +lln = 1 | lw = 0 | lwn = 1 |
| +lwl = 0 | capmod = 2 | tpb = 0 |
| +tpbsw = 0 | tpbswg = 0 | tcj = 0 |
| +tcjsw = 0 | tcjswg = 0 | noff = 1 |
| +acde = 1 | moin = 15″ | |

Actual BSIM Model parameters for the operation of a PL transistor (type p) at 20 degrees Kelvin are:

| | | |
|---|---|---|
| +version = 3.3 | tnom = −253 | tox = 9.5e−09 |
| +xj = 1.5e−07 | nch = 1.7e+17 | vth0 = −0.55033 |
| +k1 = 0.0001 | k2 = 0 | k3 = 80 |
| +k3b = 0 | w0 = 2.5e−06 | nlx = 1.74e−07 |
| +dvt0w = 0 | dvt1w = 0 | dvt2w = 0 |
| +dvt0 = 2.2 | dvt1 = 0.53 | dvt2 = 0 |
| +u0 = 0.1024 | ua = 1.6e−08 | ub = 1e−21 |
| +uc = 0 | vsat = 5000 | a0 = 1 |
| +ags = 0 | b0 = 0 | b1 = 0 |
| +keta = −0.047 | a1 = 0 | a2 = 1 |
| +rdsw = 0 | prwg = 0 | prwb = 0 |
| +wr = 1 | wint = 0 | lint = 0 |
| +xl = 0 | xw = 0 | dwg = 0 |
| +dwb = 0 | voff = −0.1 | nfactor = 1 |
| +cit = 0 | cdsc = 0.00024 | cdscd = 0 |
| +cdscb = 0 | eta0 = 0.08 | etab = 0 |
| +dsub = 0.56 | pclm = 1.3 | pdiblc1 = 0.39 |
| +pdiblc2 = 0.0086 | pdiblcb = 0 | drout = 0.56 |
| +pscbe1 = 4.2e+08 | pscbe2 = 5e−05 | pvag = 0 |
| +delta = 0.01 | mobmod = 1 | prt = 0 |
| +ute = −1.5 | kt1 = 0 | kt1l = 0 |
| +kt2 = 0 | ua1 = 4.3e−09 | ub1 = −7.6e−18 |
| +uc1 = −5.6e−11 | at = 33000 | nqsmod = 0 |
| +wl = 0 | wln = 1 | ww = 0 |
| +wwn = 1 | wwl = 0 | ll = 0 |
| +lln = 1 | lw = 0 | lwn = 1 |
| +lwl = 0 | capmod = 2 | tpb = 0 |
| +tpbsw = 0 | tpbswg = 0 | tcj = 0 |
| +tcjsw = 0 | tcjswg = 0 | noff = 1 |
| +acde = 1 | moin = 15″ | |

Employing the above data (or equivalent data under different conditions), one may model the operational effectiveness of an integrated circuit, semiconductor or transistor under an extreme condition. First, a room temperature 300K model was developed as a baseline model for each transistor type (RP, RN, NL, PL) to enable the appropriate relative extraction of the 20K, extreme environment transistor model. The method of extraction for the 300K model is the same followed for the extraction of the 20K that was detailed hereinabove.

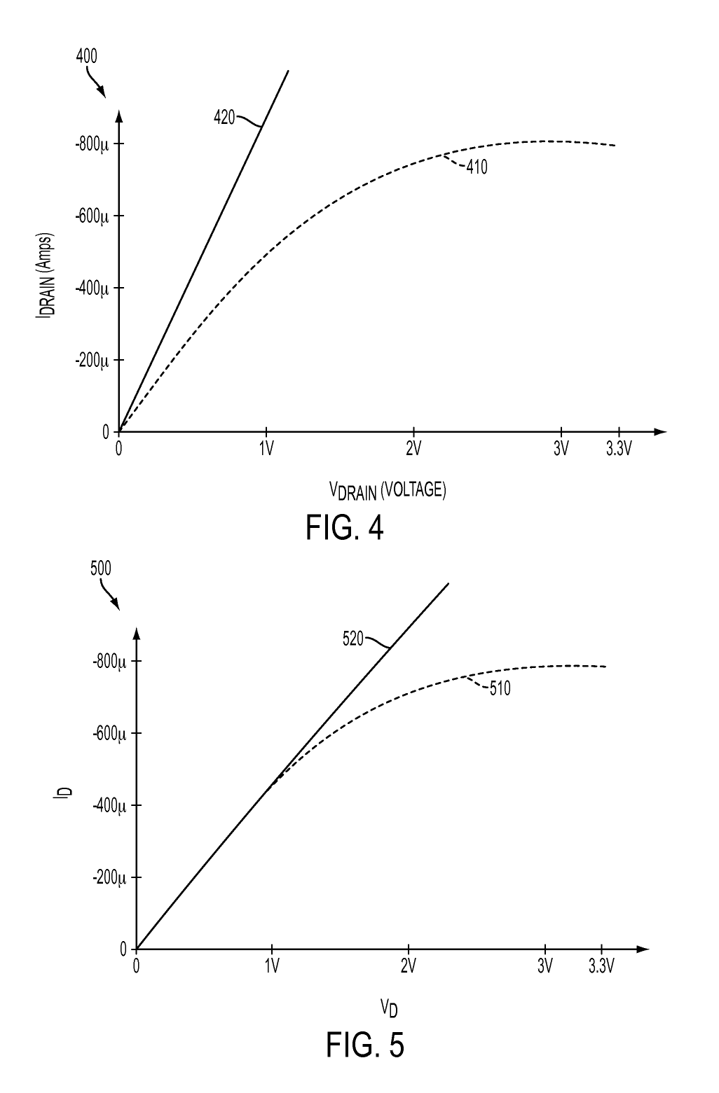

With reference now to FIG. 4 of the Drawings, there is illustrated therein an exemplary baseline transformation plot employed in practicing the present invention, designated by the reference numeral 400. As shown, the plot 400 has two curves, the first curve is the measured data curve, generally designated by the reference numeral 410, which illustrates actual performance values of the integrated circuit under consideration, e.g., those actual performance values known through measurement. The other curve is the model “fit” curve or estimate curve, generally designated by the reference numeral 420. As clearly shown, the estimate curve 420 in this initial or baseline approximation substantially diverges from the measured data, making the estimate curve 420 an initial poor fit for the measured data curve 410, and making any performance estimate therefrom suspect or with known degrees of error inherent. In particular, the estimate curve 420 of FIG. 4 diverges from the measured data curve 410 starting at the origin point, and actually fails to provide any accurate measure.

With reference now to FIG. 5, there is shown a curve fitting technique employing the principles of the present invention, as elaborated upon hereinabove, and generally designated by the reference numeral 500. As discussed, the creation of the model cards, data points and the other curve information, e.g., derivatives, provides a degree of curve fit to the measured data curve 510. This initial application of the techniques of the instant invention clearly illustrates the better fit of the calculated estimate curve 520 to the measured data curve 510, at least for the initial data values. Through the employment off the tools of the present invention, a researcher may now with more confidence model integrated circuits and component parts with more realistic performance data, resembling the conditions desired, such as within extreme environments and near absolute zero. For a range of values, the estimate curve 520 computed by the present invention provides an accurate portrayal of the performance characteristics of the component or system being modeled.

Although the estimate curve 520 is close to the measured data curve 510 and provides a good estimate for many initial values, the principles of the present invention can be further employed, through continued processing of the model cards and other data described hereinabove, to more finely tune the approximation (the curve fit) to more detailed precision, thereby generating a better simulation of the conditions and performance characteristics of integrated circuitry, transistors and other parts and assemblages thereof under various conditions, particularly more extreme conditions outside of normal operating parameters.

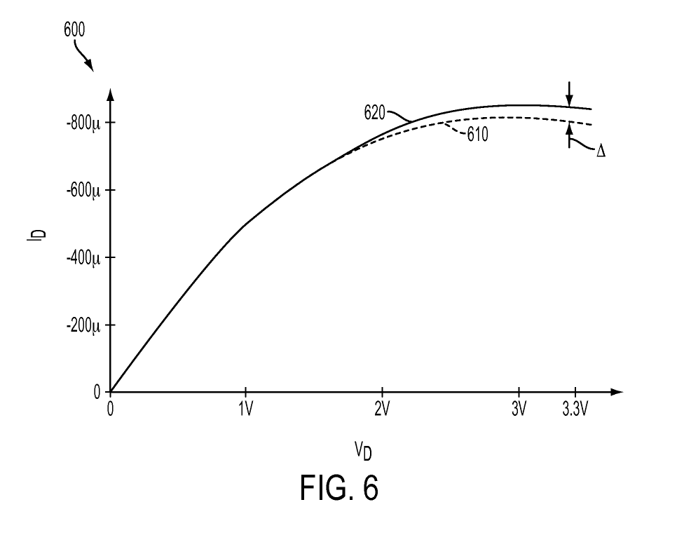

With reference now to FIG. 6 of the Drawings, there is illustrated an exemplary further usage of the present invention, generally designated by the reference numeral 600, which even better approximates the measured data curve. As shown in FIG. 6, the estimate curve 620 nearly coincides with the measured data curve 610 over a wide range of values, only diverging slightly towards the end of the curve, with a margin of error delta, which, of course, can be minimized further with more usage of the present invention to even better fit the curve. Accordingly, usage of the estimated data in this embodiment better mimics the actual measured data of the components, which may be intermittent or absent. Usage of the data generated here in the aforementioned computer simulation can, therefore, result in a close approximation of the actual conditions being modeled, such as temperatures at 20 degrees Kelvin.

It should, therefore, be understood that the system, tool and methodology of the present invention for evaluating the operational parameters of various integrated circuit computers, such as transistors and assemblages thereof, and ascertaining the capabilities and functionalities of those components under a range of tolerances, particularly in extreme environments, can be employed in a variety of ways, e.g., software, hardware and combinations thereof, as is understood to those of skill in the art. It should be understood that the procedures, protocols and algorithms employed may be written in a variety of computer languages or be hardwired for more efficiency, e.g., in specialized semiconductor chips. It should be understood that the various steps employed in practicing the present invention can be done on multiple computers 110, multiple displays 140 and through multiple data input interfaces 150.

Although the instant invention has a preferred usage in testing transistors and other integrated circuit components and assemblages thereof for extreme environments, the principles of the invention are applicable in other contexts as well. For example, although the extremes of outer space usage are the primary usage by Applicant, the present invention may be employed terrestrially to better model other conditions, such as in other extreme conditions, whether terrestrial environment or other Earth (or extraterrestrial planetary or satellite) conditions, such as volcanoes, earthquakes, seismic events, hurricanes, tornados or other such events. Similarly, the principles of the present invention may be employed in modeling component and/or system capabilities in other contexts involving extremes of different sorts, in metal works, plastics, petroleum, food processing, or other usages where the known events can be modeled and built upon to estimate unknown conditions.

While the foregoing written description of the invention enables one of ordinary skill to make and use what is considered presently to be the best mode thereof, it should be understood that various changes, substitutions and alterations can be made herein without departing from the spirit and scope of the invention as defined by the appended claims. Therefore, the invention is not to be limited by the above described embodiment, method, and examples, but by all embodiments and methods within the scope and spirit of the invention as claimed.

I claim:

1. A tool to model component performance under a condition comprising:
generating means to generate, from a plurality of baseline data, a plurality of data points;
estimating means to estimate, through curve fitting through said plurality of data points, a performance curve relating to said condition; and
simulating means to simulate performance functionality of said component under said condition,
whereby performance capabilities of said component in an extreme environment may be tested before deployment.

2. The tool according to claim 1, wherein said baseline data comprise a plurality of model card extractions.

3. The tool according to claim 2, wherein said model cards comprise a plurality of data elected from the group consisting of BSIM parameters, fabrication constants, mobility parameters and combinations thereof.

4. The tool according to claim 1, wherein curve fit through said data points is smoothed.

5. The tool according to claim 4, wherein said curve is smoothed by a least squares technique.

6. The tool according to claim 1, wherein said component is part of an integrated circuit.

7. The tool according to claim 1, wherein said component modeled comprises an integrated circuit.

8. The tool according to claim 1, wherein said component modeled comprises a plurality of integrated circuits.

9. The tool according to claim 1, wherein a plurality of conditions are modeled.

10. The tool according to claim 1, wherein said condition is low temperature.

11. The tool according to claim 1, wherein said baseline data used by said generating means employs temperature data derived from temperatures selected from the group consisting of: 300 K, 200K, 100K, 90K, 80K, 77K, 70K, 60K, 50K, 40K, 30K, 20K, 15K, and combinations thereof.

12. A system for modeling component capabilities under a condition comprising:
model means for generating a plurality of data points from a plurality of baseline data for said component;
a curve fitting means for creating a curve through said plurality of data points, said curve representing the capabilities of said component under said condition; and
a simulator, wherein information on said capabilities about said component under said condition is displayed,
whereby performance capabilities of said component in an extreme environment may be tested before deployment.

13. The system according to claim 12, wherein said baseline data comprise a plurality of model card extractions.

14. The system according to claim 13, wherein said model cards comprise a plurality of data elected from the group consisting of BSIM parameters, fabrication constants, mobility parameters and combinations thereof.

15. The system according to claim 1, wherein curve fit through said data points is smoothed.

16. The system according to claim 15, wherein said curve is smoothed by a least squares technique.

17. The system according to claim 12, wherein said component is part of an integrated circuit.

18. The system according to claim 12, wherein said component modeled comprises an integrated circuit.

19. The system according to claim 12, wherein said component modeled comprises a plurality of integrated circuits.

20. The system according to claim 12, wherein a plurality of conditions are modeled.

21. The system according to claim 12, wherein said condition is low temperature.

22. The system according to claim 12, wherein said baseline data used by said generating means employs temperature data derived from temperatures selected from the group consisting of: 300 K, 200K, 100K, 90K, 80K, 77K, 70K, 60K, 50K, 40K, 30K, 20K, 15K, and combinations thereof.

23. A method for modeling component capabilities under a condition comprising:
modeling a plurality of data points from a plurality of baseline data for said component;
generating, from a plurality of baseline data, a plurality of data points;
estimating, through curve fitting through said plurality of data points, a performance curve relating to said condition; and
simulating performance functionality of said component under said condition,
whereby performance capabilities of said component in an extreme environment may be tested before deployment.

24. The method according to claim 23, wherein said baseline data comprise a plurality of model card extractions.

25. The method according to claim 24, wherein said model cards comprise a plurality of data elected from the group consisting of BSIM parameters, fabrication constants, mobility parameters and combinations thereof.

26. The method according to claim 23, wherein curve fit through said data points is smoothed.

27. The method according to claim 26, wherein said curve is smoothed by a least squares technique.

28. The method according to claim 23, wherein said component is part of an integrated circuit.

29. The method according to claim 23, wherein said component modeled comprises an integrated circuit.

30. The method according to claim 23, wherein said component modeled comprises a plurality of integrated circuits.

31. The tool according to claim 23, wherein a plurality of conditions are modeled.

32. The tool according to claim 23, wherein said condition is low temperature.

33. The tool according to claim 23, wherein said baseline data used by said generating means employs temperature data derived from temperatures selected from the group consisting of: 300 K, 200K, 100K, 90K, 80K, 77K, 70K, 60K, 50K, 40K, 30K, 20K, 15K, and combinations thereof.
